(19) United States
(12) Patent Application Publication
(10) Pub. No.: US 2008/0187701 A1
(43) Pub. Date: Aug. 7, 2008

(54) Tpe/Pp/Reinforcement Multilayer Tube

(76) Inventor: Johann Dabouineau, ampierre- Au Temple (FR)

Correspondence Address: DYKEMA GOSSETT PLLC, 39577 WOODWARD AVENUE, SUITE 300, BLOOMFIELD HILLS, MI, 48304-5086, US

(21) Appl. No.: 11/577,574

(22) PCT Filed: Oct. 19, 2005
(86) PCT No.: PCT/FR05/02593

§ 371 Date: Feb. 1, 2008

(30) Foreign Application Priority Data
Oct. 19, 2004 (FR) 0411064

(51) Int. Cl. B32B 1/08

(52) U.S. Cl. 428/36.91

(57) ABSTRACT

A multilayer tube that comprises, from the inside to the outside:

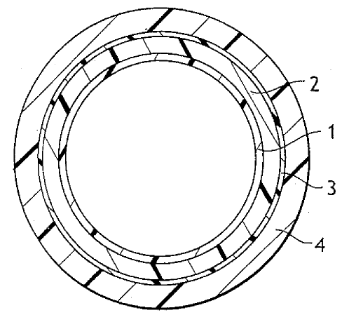

an inner layer of thermoplastic elastomer (1) that is compatible with polypropylene;

an intermediate layer of polypropylene (2) that is in direct contact with the inner layer; and

an outer reinforcement layer (4).

The present invention relates to a multilayer tube usable in particular as a fluid transport pipe in a cooling circuit for a motor vehicle engine.

Numerous tube structures exist for transporting cooling fluid. The choice of materials forming the layers of said structures is the result of a compromise between ability to withstand the transported fluid, permeability to said fluid, mechanical strength, and the cost of the tube.

This compromise is particularly difficult to find when the tube is subjected to high temperatures, typically greater than 150° C.

A tube has been envisaged that comprises a layer of polyamide and a layer of thermoplastic elastomer that have been made mutually compatible. Nevertheless, in such a tube, high temperature leads to breaking of the covalent bonds between maleic anhydride and the amine functions of the polyamide or any other function serving to make the two layers compatible. In addition, such covalent bonds are very sensitive to chemical attack from the transported fluid, which can lead to the layers becoming delaminated.

Tubes made of thermoplastic elastomer are also known. Nevertheless, those tubes are expensive and present relatively high permeability.

An object of the invention is to provide a tube structure enabling a better compromise to be obtained between the various above-mentioned constraints.

To this end, the invention provides a multilayer tube that comprises, from the inside to the outside:
an inner layer of thermoplastic elastomer that is compatible with polypropylene;
an intermediate layer of polypropylene that is in direct contact with the inner layer; and
an outer reinforcement layer.

The polypropylene layer provides the main part of the barrier function against the cooling fluid. The thermoplastic elastomer layer also provides a barrier function, thus enabling it to back up the polypropylene layer. Because of its flexibility, the inner layer of thermoplastic elastomer presents good resistance to cracking, thereby preventing the transported fluid being put into contact with the intermediate layer over a relatively long period of time, thus enabling the intermediate layer to conserve its barrier properties against the transported fluid. The inner layer thus protects the polypropylene of the intermediate layer from attack due to the cooling fluid, and also enables the tube to be connected onto endpieces of the type having Christmas-tree serrations. The thermoplastic elastomer also presents a property of adhering naturally to polypropylene (there is interpenetration at macromolecular level between polypropylene and the thermoplastic elastomer) up to temperatures that are relatively high (above 150° C.). There is synergy between the inner layer and the intermediate layer that allows the tube to have good performance. The outer layer reinforces the tube mechanically and gives it good resistance to temperature and pressure.

Other characteristics and advantages of the invention appear on reading the following description of a particular, non-limiting embodiment of the invention.

Reference is made to the sole accompanying FIGURE showing a tube in accordance with the invention in cross-section.

The tube in accordance with the invention comprises, from the inside to the outside:
an inner layer 1;
an intermediate layer 2;
a binder layer 3; and
an outer reinforcement layer 4.

The inner layer 1 comprises a thermoplastic elastomer (TPE) material.

The thermoplastic elastomer material in a first version of the invention is a thermoplastic elastomer olefin (TPE-O) alloy, that is not vulcanized in this example.

The thermoplastic elastomer olefin mate rial comprises a majority phase of polyolefin and a minority phase based on elastomer that is dispersed in the majority phase. The thermoplastic elastomer olefin alloy material used is constituted, by way of example, by one of those products sold by the supplier Multibase under the reference Multibase.

In a second version, the thermoplastic elastomer material used may optionally be vulcanized (TPV) and comprises ethylene-propylene-diene monomer (EPDM). Specifically, the material used is a mixture of polypropylene and of ethylene-propylene-diene monomer (PP/EPDM) of the kind produced by the supplier AES under the references Santoprene 101-64A, 101-73A, 101-80A, 101-87A, 201-64A, 201-73A, 201-80A, or 201-87A.

In a third version, the thermoplastic elastomer material used is a thermoplastic elastomer and styrene (TPE-S) alloy, in this example comprising a polypropylene base having styrene-butadiene-styrene (SBS) or styrene-ethylene-butadiene-styrene (SEBS) dispersed therein.

The inner layer 1 presents good resistance to the cooling fluid and low permeability thereto. The inner layer 1 presents the advantage of being deformable, thus enabling it to provide a sealing function when the tube is connected to an endpiece, e.g. one of the type having Christmas-tree serrations. The inner layer 1 is preferably of a grade that is stabilized against thermal aging in air, e.g. by incorporating anti-oxidants.

The intermediate layer 2 is made of polypropylene (PP) such as polypropylene of the EPD60R grade (heat stabilized and protected against oxidation and aging by hydrolysis) produced by the supplier Degussa under the references SX8100 or SX8100sw; or it may be as produced by the supplier Solvay Engineering Polymers under the reference Sequel 1420 or Eltex PHL 102 engineered polyolefin; or else it may be that produced by the supplier Bamberger Polymers under the reference Bapolene Grade PP 4012.

The materials of the inner layer 1 and of the intermediate layer 2 present properties of mutual adhesion. This is particularly advantageous since this adhesion prevents (or at very least limits) recondensation between the layers of any fluid vapor that might have managed to pass through the inner layer and become blocked by the intermediate layer. Such recondensation would lead to bubbles that would run the risk of damaging the cohesion of the tube and weakening it, in particular mechanically.

The layer of binder 3 is based on maleic anhydride grafted polyolefin (PO-g-MA) of the kind produced by the supplier Mitsui Chemicals under the references Admer QB 520, QF 550 E, QB 510 E, QF 551 E, AT 843 E, AT 1190 E, AT 1647 E, or AT 1658 E; or by the supplier Equistar under the references Plexar PX 6002 or PX 6006.

The outer layer 4 is made of polyamide 6-12 (PA 6-12) such as that produced under the references: Vestamid DX 9304 or DX 9303 or X 7099 by the supplier Huls; Grilon CAE 6 or CR9 NAT 6361 by the supplier Mems-Grivory; Ashlene 982 by the supplier Ashley Polymers; or Comtuf 608 by the supplier Comalloy; Zytel 151 L NC010 or EFE 4168 by the supplier Dupont de Nemours. Polyamide 6-12 gives the tube relatively great resistance to temperature and pressure.

In a variant, the outer layer comprises a majority phase of polyphenylene sulfone (PPS). In a first version, the material used is a mixture of polyphenylene sulfone with an impact modifier such as that produced by the supplier Chevron Philips under the references XTEL XE 3200 or 3400. In a second version, the material used is a mixture of polyphenylene sulfone and polyamide such as that produced by the same supplier under the reference XTEL, series XK.

By way of example, for a tube having an inside diameter equal to 27 millimeters (mm), the inner layer has a thickness of 0.20 mm, the intermediate layer has a thickness of 0.20 mm, the binder layer has a thickness lying in the range 0.05 mm to 0.10 mm, and the outer layer has a thickness of 0.90 mm (the values given are orders of magnitude). The permeability of the tube decreases with increasing thicknesses.

The various layers may be coextruded, for example.

During fabrication of the tube, cooling must not be too fast, so as to obtain a crystal content that is sufficient to limit the permeability of the tube to the desired value. Extrusion enables cooling to take place relatively slowly, from the outside towards the inside.

The tube may be smooth or corrugated.

When the tube is corrugated, the inner layer 1 protects the intermediate layer 2 from stress-cracking in particular.

Naturally, the invention is not limited to the embodiment described and variant embodiments can be applied thereto without going beyond the ambit of the invention as defined by the claims.

In particular, other thermoplastic elastomers, polypropylenes, binders, and polyamides could be used (in particular polyamide 12 even though it presents a maximum utilization temperature lower than that of PA 6-12).

The binder layer may be made of a material other than that described, in particular when the reinforcement outer layer is itself made of a material different from that described.

In addition, it is possible to select a reinforcement outer layer that is made of a material having natural properties of adhesion with the polypropylene intermediate layer. There is then no point in interposing between these layers a layer of binder if the cohesion between the layers obtained by natural adhesion is sufficient for the intended application.

What is claimed is:

1. multilayer tube that comprises, from the inside to the outside:
an inner layer of thermoplastic elastomer (1) that is compatible with polypropylene;
an intermediate layer of polypropylene (2) that is in direct contact with the inner layer; and
an outer reinforcement layer (4)

2. A tube according to claim 1, wherein the outer layer (4) is of polyamide.

3. A tube according to claim 1, wherein the outer layer (4) is of polyamide 6-12.

4. A tube according to claim 1, wherein the outer layer (4) has a majority phase of polyphenylene sulfone.

5. A tube according to claim 1, the tube having a binder layer (3) of maleic anhydride grafted polyolefin.

6. A tube according to claim 1, wherein the inner layer (1) is of a vulcanized thermoplastic elastomer.

7. A tube according to claim 1, wherein the inner layer (1) is of a thermoplastic elastomer and olefin alloy.

8. A tube according to claim 1, wherein the inner layer is of a thermoplastic elastomer and styrene alloy.

9. A tube according to claim 8, wherein the styrene thermoplastic elastomer comprises a base of polypropylene in which styrene-butadiene-styrene is dispersed.

10. A tube according to claim 8, wherein the styrene thermoplastic elastomer comprises a base of polypropylene in which styrene-ethylene-butadiene-styrene is dispersed.
